(19) United States
(12) Patent Application Publication
(10) Pub. No.: US 2019/0279157 A1
(43) Pub. Date: Sep. 12, 2019

(54) AUTOMATED BUSINESS TRANSACTION CREATION FOR EMAIL SYSTEM

(71) Applicant: Morgan Stanley, New York, NY (US)

(72) Inventors: Sujit Eapen, Princeton, NJ (US); SoniI Trivedi, New York, NY (US)

(21) Appl. No.: 15/912,726

(22) Filed: Mar. 6, 2018

(51) Int. Cl. G06Q 10/10; H04L 29/06; H04N 1/00

(52) U.S. Cl. CPC G06Q 10/103; H04N 1/00209; H04L 63/0807; G06Q 10/107

(57) ABSTRACT

A system for automated email task management comprising an email server, a workflow server, a document storage server, and a computing device having non-transitory memory storing email client software, workflow client software, and a bridging software. Upon receipt of an email, the bridging software determines that the email contains instructions requiring initiation of a workflow, the bridging software automatically converts security credentials from a first security scheme used by the email client software to a second security scheme used by the workflow client software, and the bridging software provides a user interface that allows a user to automatically initiate a workflow in the workflow client with one or more data elements of the instructions prefilled in a graphical user interface of the workflow client software.

### FIELD OF INVENTION

This application relates to methods and systems for modifying user interfaces in communications software, document management software, and business workflow software, and providing a framework and software library to securely automate the storage of and implementation of a variety of incoming consumer indications of intent.

### BACKGROUND

In a number of commercial industries, customer service representatives spend a great deal of time receiving orders from customers to purchase goods and assets. They also perform a number of other account transactions such as updating account contact information, changing the beneficiary of an account, or updating permissions to add or remove named account owners or authorized users.

Customer service representatives save information regarding customer orders for company record-keeping purposes and, because the requests may come in a variety of non-standardized formats, including handwritten requests, older and deprecated forms, or emails that textually describe the customer order and rely on interpretation by a representative to be implemented.

Customer service representatives often have to transcribe customer orders into a computerized system unique to a particular company, slowing down fulfillment of the order and introducing the possibility of error in the order, or error in where the original document from the customer is stored, if records regarding authority for a transaction need to be consulted. Task switching from reading a customer communication, to entering information in a separate interface, to saving documents using a third interface causes increased opportunity for user error and less efficiency as the mind reorients itself to the separate tasks.

As a result, there is a need for automated systems that reduce user error, make customer service more time-efficient and responsive to customer needs, and improve compliance with data retention requirements.

### SUMMARY OF THE INVENTION

A system is disclosed for automatically reading the contents of emails and attachments to determine customer intent, manage document storage to comply with record-keeping requirements, initiate a new business workflow to satisfy the customer's intent, and prefill as many elements of the business workflow as possible.

A system for automated email task management is disclosed, comprising at least an email server, a workflow server, a document storage server, and a computing device having non-transitory memory storing email client software, workflow client software, and a bridging software. In the system, upon receipt of an email by the email client software, the bridging software determines that the email contains instructions requiring initiation of a workflow in the workflow client software, the bridging software automatically converts security credentials from a first security scheme used by the email client software to a second security scheme used by the workflow client software, and the bridging software provides a user interface that allows a user to automatically initiate a workflow in the workflow client with one or more data elements of the instructions prefilled in a graphical user interface of the workflow client software.

Additionally, a method for modifying a plurality of existing graphical user interfaces (GUIs), is disclosed. The method comprises adding, via a plugin and to an email client GUI, a command to obtain, from an email accessible by the email client, instructions requiring initiation of a workflow in a workflow client. In response to triggering the command, software used to perform the method automatically identifies, from the instructions, one or more data elements necessary to initiate the workflow in the workflow client; automatically stores, in a document management server, a representation or copy of the instructions; automatically initiates a workflow in the workflow client; and automatically prefills, in a GUI of the workflow client, one or more data fields with the one or more data elements.

A method of accurately initiating workflows in response to a received indication of intent is also disclosed. The method comprises receiving a digital communication comprising a digital attachment via communication client software, automatically determining that the digital attachment contains instructions requiring initiation of a workflow in workflow client software, and automatically obtaining one or more data elements of the instructions from the digital attachment. Then, the system automatically converts security credentials from a first security scheme used by the communication client software to a second security scheme used by the workflow client software and provides a graphical user interface that, when engaged by a user, initiates a workflow in the workflow client with the one or more data elements of the instructions automatically prefilled in a graphical user interface of the workflow client software.

### BRIEF DESCRIPTION OF THE DRAWINGS

FIG. 1 depicts a computer system for receiving and acting upon communications from a client.

FIG. 2 depicts a method for responding to a client's request by initiating a workflow.

FIG. 3 depicts an example graphical user interface for initiating a workflow from an email client.

FIG. 4 depicts in greater detail the user interface for workflow initiation incorporated into the client depicted in FIG. 3.

### DETAILED DESCRIPTION

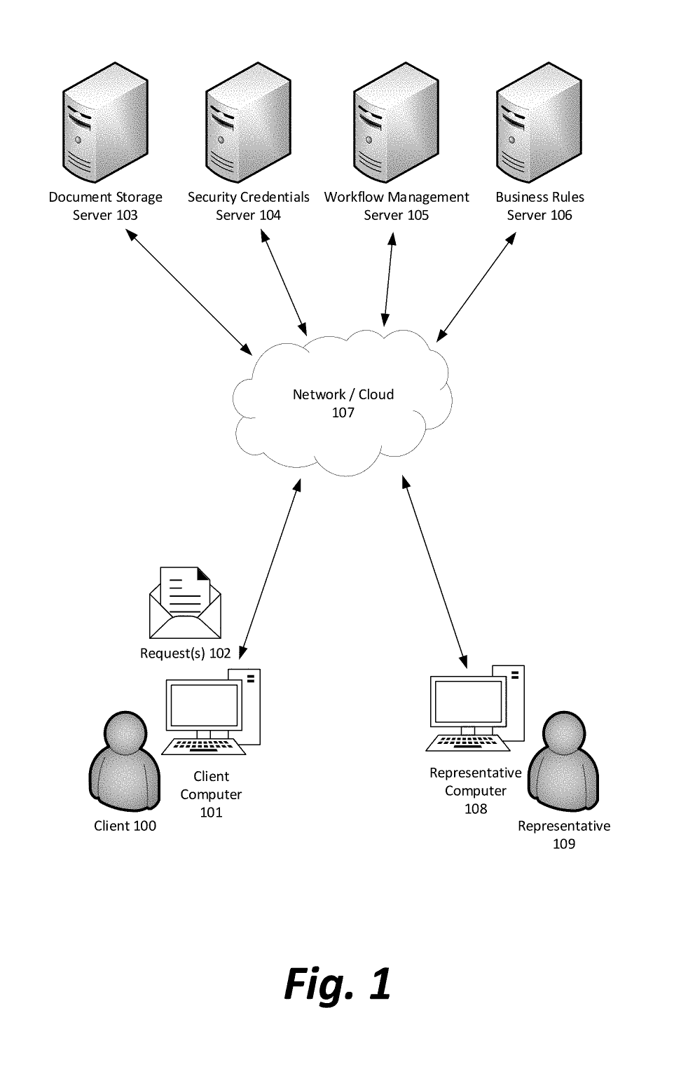

FIG. 1 depicts a computer system for receiving and acting upon communications from a client.

With reference now to FIG. 1, a client 100 may use a client computing device 101 to receive one or more forms for requests 102 from a document storage server 103. The client computing device 101 may be, for example, a customer's desktop computer, laptop, tablet, mobile phone, or any other computing device. Client computing device 101 is connected to representative computing device 108, and may be connected to the document storage server 103 and/or to security credentials server 104 via network 107. Representative computing device 108 may be connected to one or more of document storage server 103, security credentials server 104, workflow management server 105, and business rules server 106 via network 107. The representative computing device 108 may likewise be a desktop computer, laptop, or other computing device.

When reference is made throughout this specification to client computing device 101 or representative computing device 108 being used to perform an action, the actual processor and memory used to perform the action may be located in a remote device, with the computing device 101 or 108 being used as a “thin client” or “dumb terminal” that provides a local graphical user interface for software running on a remote server, allowing client 100 or representative 109 to trigger actions on the remote server via commands issued at client computing device 101 or representative computing device 108, respectively.

In some embodiments, network 107 may be a private network for representative computing device 107 and servers 103-106, with a gateway that prevents communication between the client computing device 101 and those servers 103-106; in other embodiments, the network 107 may simply represent a cloud based server infrastructure to which both client computing device 101 and representative computing device 108 may connect.

In a preferred embodiment, the form for request 102 is stored in the portable document format (PDF), tailored by the service provider to correspond to a specific workflow or set of workflows, with fillable form fields to standardize customer input, potentially enforce data validation rules (such as, for example, an amount being a number rather than a string), and make machine extraction of the form data simpler.

In alternative embodiments, the request form may be a PDF without fillable form fields (such as a converted scan of a pre-made form tailored to one or more workflows), an alternate type of pre-created form (such as in Microsoft Word™, another office open extensible markup language (OOXML) file format, another word processing format, or a desktop publishing format), or even a plain text format.

In some embodiments, the request 102 may be a PDF file or other file that is encrypted, either according to a security feature within the file (such as a password-protected PDF function) or due to encryption of the file's binary representation itself. If the request 102 is encrypted, a security server 104 may be used either to obtain a public key that should be used for the encryption process

Similarly, in some embodiments, the request 102 may, before or after being filled out or created by client 100, be “zipped”, archived, compressed, etc. into an intermediary format that requires unzipping, unpacking, decompression, etc., as appropriate.

In an alternative embodiment, the request form 102 may be generated by the client 100 himself, either using word processing or other document preparation/desktop publishing software.

In yet another alternative embodiment, the request 102 may be created by taking a photograph or scan of a printed-out form or even a blank sheet of paper upon which the client 100 has handwritten, typewritten, or otherwise added information.

The client 100 may cause the request 102 to be attached to an email message 104 and transmitted to a customer service computing device 105. In some embodiments, multiple requests may be attached to a single email, and in some embodiments

In alternative embodiments, request 102 could be instead attached to a text message (if client computing device 101 and representative computing device 108 are both mobile phones) or to any other data format for transmission to and receipt by a communications client on the representative computing device 108.

After causing the request 102 to be transmitted via network 107 to representative computer 108, customer representative 109 may use the representative computer 108 to open the request 102 and review what service client 100 intends to have performed.

Representative computer 108 may be connected via network 107 to a document storage server 103 (for the storage and retrieval of blank forms for use by clients or filled-out forms for storage while being processed and for records-keeping compliance), a security credentials server 104 (for the storage of passwords or keys for encryption and decryption of documents, or login information and credentials for various domains to which the client or representative may have access), workflow management server 105 (for storing information regarding in-progress or completed workflows), and business rules server 106 (for storing information regarding policies that must be followed by the client and representative, such as what information must be provided along with a client request to be honored, or what types or levels of representatives are permitted to execute a particular workflow type).

Although FIG. 1 displays four servers 103, 104, 105, and 106, the functionality that is ascribed in the various embodiments of this disclosure to one of these servers may be divided among multiple servers (such as, for example, having a first document server to serve one kind of document, and a second document server to store a second kind of document), or consolidated into a single server performing multiple roles (such as, for example, a single server that acts as both a workflow management server and a business rules server).

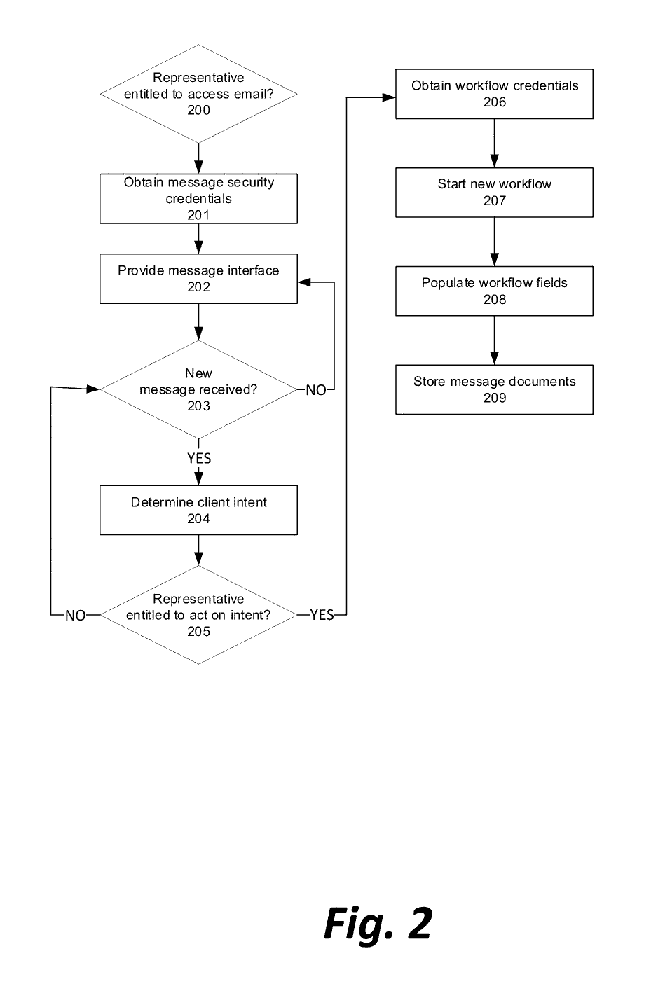

FIG. 2 depicts a method for responding to a client's request by initiating a workflow.

With reference now to FIG. 2, when the representative 109 begins using the representative computer 108, it is first determined whether the representative has rights to access emails or other communications sent by clients to an organizational domain (Step 200). If the representative lacks these rights, the process ends with the representative excluded from using an email client to access the clients' emails. Whether the representative has rights may be determined by checking a provided username and/or password against a database stored on security credentials server 104 or a similar server for the organization.

If the representative does have the rights, the representative may be issued (and may have stored on the computer for the duration of the session) a token, cookie, or other security credential (Step 201). In a preferred embodiment, Kerberos may be the security scheme used by the organization for controlling access to various software, including the communications client described below. In alternate embodiments, other security schemes may be used to enforce permissions.

If credentials are provided, the representative is provided with an email client user interface to access the set of client communications to which the representative is entitled (Step 202). In a preferred embodiment, this interface may be provided by Microsoft Outlook™. In other embodiments, the interface may be provided by another client, such as Mozilla Thunderbird™, or by a webmail interface rather than a desktop program.

While the representative uses the communications client, the client continually checks for new incoming messages (Step 203). If no new message is found, the client may wait for a period of time and check again.

If a new message is received, a plugin added to the communications client may check to see if the body of the message or its attachments contain a client request for the representative to undertake some action on the client's behalf (Step 204). The plugin may utilize an application programming interface (API) of the communications client to add additional functionality to the client, as described throughout the disclosure below. The determination may include determining that at least one attachment to an email is a standard form used by the organization or determining that a form, while non-standard, matches the fields of a particular form used by the organization (i.e., the form lists at least some same data elements, such as account number or name, even if in an incorrect order or placement). The determination of the user's intent and the reason for which they have sent the form may be as simple as verifying that the form is an organization-provided form that contains a predefined title, text, bar code, QR (quick response) code, serial number, or other unique identifier. If the form is non-standard, in contrast, such as one created by a user, the determination may require attempting to “scrape” one of more text fields from the file and determining what significance they have to any possible workflow, or even using optical character recognition (OCR), natural language processing, or other artificial intelligence techniques to determine which form type is a most likely match. If the client has handwritten, typewritten, or taken a photograph of scan of a request to send in with the message, OCR, natural language processing, or similar techniques may be required for an automated system to have any hope of determining the client's intent in sending the form. An archived or encrypted form may require software to automatically unpack or decrypt the file, to obtain decryption credentials from a credentials server, or to prompt the user for decryption credentials.

Once the determination of the client's intent is made, the plugin may check whether the representative is entitled to act upon the client intent (Step 205). In some embodiments, particular workflows may require that the actor who completes a given workflow be, for example, a manager in the organization, an executive, or at least of some level within a particular organizational hierarchy. Other workflows may allow any person within the customer service arm of the organization to act on and fulfill the request. Various rules regarding permissions to perform a particular workflow may be stored in business rules server 106 and retrieved regularly by the plugin to allow changes in representative permissions and other business rules without having to reinstall the plugin or modify any software running on the representative computer.

If the representative is entitled, the representative may need to obtain separate credentials for a workflow management software that is used to update information (such as the identity and contact information of a client, the owner of an account, the beneficiary of an account, etc.) and/or take action in response to a client request (buy assets/sell assets/transfer assets, etc.) (Step 206). In a preferred embodiment, the workflow management software may use SiteMinder™ to manage permissions. In other embodiments, any number of other security schemes may be used, including other Single-Sign On solutions, Kerberos, or other security methods.

To simplify the automation of workflow management and creation, the system may comprise code to automatically convert a first security credential or token in use by the communications system to a second security credential or token to be used by the second system. A sample body of computer code for accomplishing this transfer from one credential scheme to another in a preferred embodiment can be found in Appendix A, below. In other embodiments, the user may manually enter a password to log in to the workflow management software, or if a single sign on solution is used by the organization, the credentials already provided when using the communications system or other software on the computer may already allow access to the workflow management software.

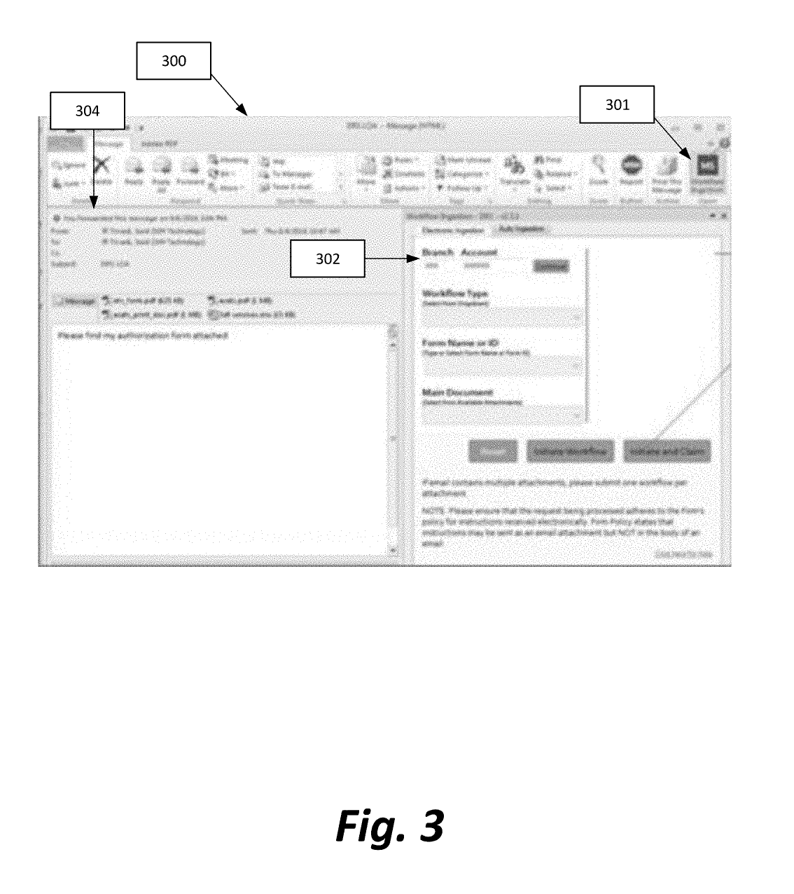

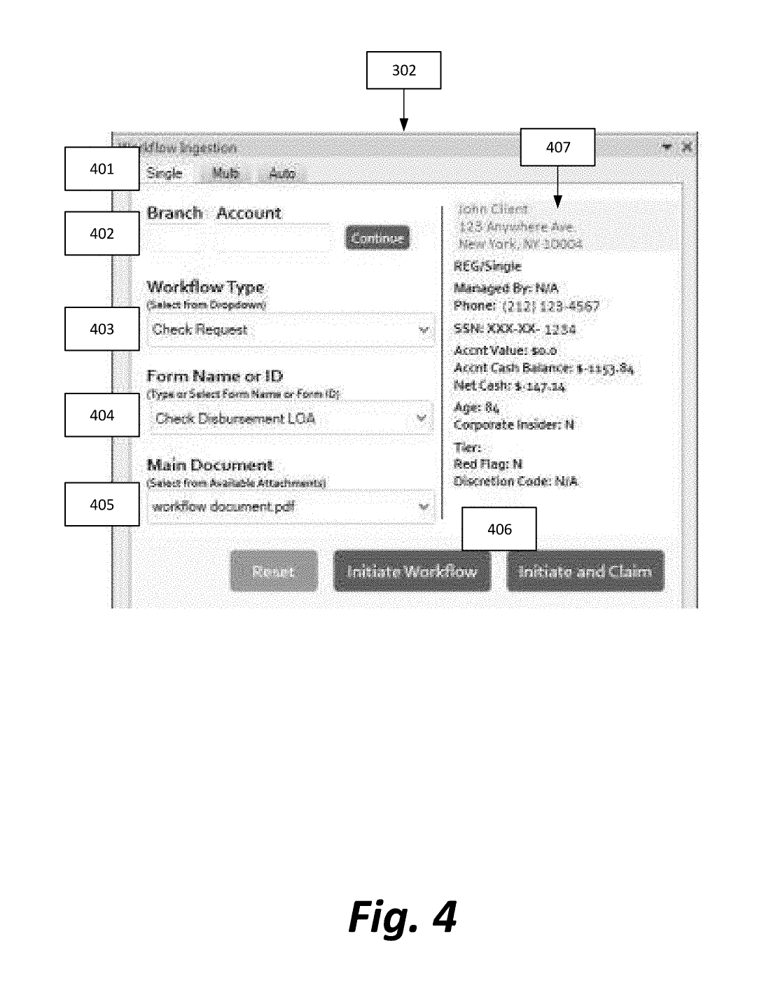

Once the representative has obtained or entered proper credentials for the workflow software, a new workflow may be initiated by the representative (Step 207). In a preferred embodiment, this can be initiated from the communications client itself, using the plugin, if the plugin has already identified the workflow type and relevant documents, and obtained any required credentials for accessing the workflow management software. An interface for confirming information from the relevant documents and initiating the workflow is shown in greater detail below, with FIGS. 3 and 4.

Once the workflow has been created, the plugin (or other software in communication with the plugin, such as an application programming interface (API) of the workflow management software) may populate one or more fields of the workflow management software (Step 208). The fields may be, for example, the client's name, account number, workflow type, the files documenting the client's request, and any other values associated with the request (such as a dollar amount to purchase, a number of shares to sell, a number of units to buy, etc.). The values to be entered in the fields may be determined by scraping them from files provided in the attached documents.

In conjunction with actually creating and executing the workflow, the files that document the client request should be saved in the document storage server 103 or another database (Step 209). By automating this step through action of the plugin or the plugin's invocation of an API, the risk of the representative saving the documents in an incorrect folder, misnaming them, or associating them with an incorrect client can be eliminated, since the plugin may store information regarding exactly where the documents should be saved to maintain the proper associations with clients and ensure that a search functionality can find the documents.

In various embodiments, a number of the steps of the method described may be performed in a different order or in parallel. For example, saving the document(s) (Step 209) may occur prior to initiating the workflow (Step 207), if documents should be saved regardless of whether they are eventually associated with a workflow; in another example, workflow credentials could be obtained (Step 206) immediately after message security credentials are (Step 201), with a view towards more quickly initiating a workflow once a suitable communication is received.

FIG. 3 depicts an example graphical user interface for initiating a workflow from an email client.

With reference now to FIG. 3, while viewing an email 304 with attachments using an email client 300 (such as Microsoft Outlook™, or another commercial or open source email client capable of installing plugins to provide additional functionality, including Mozilla Thunderbird™), the plugin software may detect the attachments and cause a button (or tab, or other contextual menu) 301 to appear, become colored instead of “grayed out,” flash, become animated, or otherwise change a visual property to indicate that a user may interact with it.

In alternative embodiments, client 300 may, instead of being an email client, be a client for a different messaging system, such as mobile phone texting or in-browser software for an online social network.

When button or other user interface element 301 is interacted with while viewing email 304, graphical user interface 302 (which is displayed in greater detail in FIG. 4, below) may appear within the client. Graphical user interface 302 may be a pane in a multi-pane environment, a separate window, or an interface that may be docked as a pane and dragged as a window according to user preferences in a modern drag-and-drop interface. Graphical user interface 302 is used to initiate a workflow using the documents attached to email 304.

FIG. 4 depicts in greater detail the user interface for workflow initiation incorporated into the client depicted in FIG. 3.

With reference now to FIG. 4, within graphical user interface 302 may be branch and account selection boxes 402, workflow type selection 403, form name selection 404, file selection 405, and initiation buttons 406. Client information 407 may also be displayed, as gathered by the plugin by using information from the email's sender header to lookup stored client profile information in a central client database stored on server 104, server 105, or another database server.

In some embodiments, a user may have to select each of the appropriate options in inputs 402, 403, 404, and 405. In some embodiments, one or more of these inputs may be pre-filled, such as by code running in the plugin determining either from an attachment's filename or from the contents of the file what the appropriate value for that selection should be. The selection by the plugin code might prefill a value only if it is certain of the proper selection (e.g., if the filename is an exact match with an expected filename for a certain document type, or if an attached file is a Tillable form matching a form provided for a specific use) or alternatively, the code might prefill a value based on a “best guess” from analyzing the filename and file contents (e. g., if the filename most closely matches a certain file format, or if the fields and words in a non-standard form indicate above a probability threshold that the document was meant for a specific workflow). If neither certainty nor a sufficiently certain guess are available based on the plugin's analysis, the inputs may remain empty for a user to fill in.

Tabs 401 may be provided to allow a user to select a different and more convenient scheme for entering or confirming data for workflow initiation. In the example embodiment depicted, tabs for “single,” “multi” (i.e., “multiple”) and “auto” (i.e., “automatic”) exist. Single mode may allow a user to initiate a single workflow (which is chosen in input 403) based on a single document (which is chosen in input 405). Multiple mode, in contrast, may allow a user to initiate more than one workflow at a time, by providing a button or other interface element that, when clicked or otherwise engaged by the user, adds additional instances of inputs 403, 404, and 405 as desired by the user. In “automatic” mode, the plugin may analyze a unique identifier in the file attachment (such as, for example, a QR code imprinted on a form) provided only to a single client beforehand and only on a single form, from which the purpose of the form can be known with certainty. In such a case, the inputs 402, 403, 404, 405, and 406 may be hidden, and replaced with a single input to confirm that a workflow should be automatically initiated. If a unique identifier is not present in the attached file, the “auto” tab may be disabled, or selecting the auto tab may notify the user that the file is not eligible for automatic workflow initiation.

If a user has filled in the various inputs 402, 403, 404, and 405, the user may select one of the options 406: “reset,” to empty the inputs of all information if one or more inputs contains erroneous values; “initiate workflow,” to cause a workflow to be created according to the input values, but no further action taken, or “initiate and claim,” to cause both creation of the workflow and assignment of the workflow to the user to continue processing it in workflow management software.

When the “initiate workflow,” “initiate and claim,” or similar choices which may exist in other embodiments are selected, the plugin may cause workflow software to be launched, and may, via an API or other system for communicating between distinct applications, cause one or more textboxes, selection boxes, or other form elements or GUI elements to be prefilled with the selections from inputs 402-404 and with one or more data elements obtained from analysis of the file indicated by input 405. As a result, the user of the workflow software is not able to make a human error in the selection of a file, selection of workflow options, or in the selection of a filename or folder for the documentation of the instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### APPENDIX A

APPENDIX A
string SmSessionCookieName =

Util.GetValueFromAppConfig(“SM_COOKIE_NAME”);

var req = (reqSub==null)?

(HttpWebRequest)HttpWebRequest.Create(Util.GetValueFromAppConfig(“kr
b2smurl”)):reqSub;

proxy = WebRequest.DefaultWebProxy;
WebRequest.DefaultWebProxy = null;
req.Method = WebRequestMethods.Http.Get;
req.UseDefaultCredentials = true;
req.CookieContainer = new CookieContainer( );
req.AuthenticationLevel =

System.Net.Security.AuthenticationLevel.MutualAuthRequested;

if(reqSub==null) req.UserAgent =

Util.GetValueFromAppConfig(“useragent”);

var res = (HttpWebResponse)req.GetResponse( );
if (res.Cookies[SmSessionCookieName] != null)
{

session = res.Cookies[SmSessionCookieName].Value;
TranLog.WriteLog(“Fetched session successfully”);

}

var transactionTypeUrl =

Util.GetValueFromAppConfigForEnvironment(“bwfbaseurl”) +
Util.GetValueFromAppConfig(“transactiontypes”);

Uri uri = new Uri(transactionTypeUrl);
var req =

(reqSub==null)?(HttpWebRequest)HttpWebRequest.Create(transactionType
Url):reqSub;

req.Method = WebRequestMethods.Http.Get;
req.CookieContainer = new CookieContainer( );
req.CookieContainer.Add(new Cookie(“SMSESSION”, session)

{ Domain = uri.Host });

var res = req.GetResponse( );
using (var resStream = res.GetResponseStream( ))
{

var reader = new StreamReader(resStream);
string responseJSON = reader.ReadToEnd( );
var transactionTypes =

Newtonsoft.Json.JsonConvert.DeserializeObject<InitiatePlugin.ViewMod
els.TransactionTypes>(responseJSON);

TransactionTypeList = transactionTypes.transactionTypes;

}

if (userConfig == null ||

(

!userConfig.isBranchManager &&
!userConfig.isBranchOps &&
!userConfig.isComplexManager &&
!userConfig.isComplexRiskOfficer &&
!userConfig.isFaCsa &&
!userConfig.isRegionalManager
) ||
userConfig.isCorporateAdmin ||
userConfig.isCorporateViewer ||
userConfig.isSRUAssociate ||
userConfig.isSRUSupervisor

)

{

TranLog.WriteLog(“User is not authorized to use Workflow

Ingestion”);

PnlErrorHeight = 25;
ErrorMsgVisiblity = true;
ErrorMsgText = “You do not have access to the Add-In for one or

more of the following reasons:” + Environment.NewLine +

“* Your Workflow role may not be authorized to initiate a

request.”;

isAuthorized = false;

}
else {isAuthorized = true;}
var reader = new StreamReader(resStream);
string responseJSON = reader.ReadToEnd( );
var forms =

Newtonsoft.Json.JsonConvert.DeserializeObject<InitiatePlugin.ViewMod
els.Forms>(responseJSON);

_dispatcher.StartNew((System.Action)delegate

{ MultiItems.Add(new WorkflowModel( ) { TransactionTypeList =
this.TransactionTypeMultiList, RemoveMultiVisibility =
Visibility.Hidden }); });

var dict = new Dictionary<string, SortedSet<Form>>( );
forms.Items.ForEach(a =>
{

SortedSet<Form> value;
var requestType = (a.RequestType == “NA”) ? “New

Account Documents” : a.RequestType;

if (!dict.TryGetValue(requestType, out value))
{

value = new SortedSet<Form>(new FormComparer( ));
diet.Add(requestType, value);

}
if (a.DisplayName != null

&& !a.DisplayName.Contains(“-- Start”))

{

value.Add(a);

}

});

What is claimed:

1. A system for automated email task management, comprising:
a workflow server;
a document storage server; and
a computing device having non-transitory memory storing email client software, workflow client software, and a bridging software;
wherein, upon receipt of an email by the email client software, the bridging software determines that the email contains instructions requiring initiation of a workflow in the workflow client software;
wherein the bridging software automatically converts security credentials from a first security scheme used by the email client software to a second security scheme used by the workflow client software; and
wherein the bridging software provides a graphical user interface that, when engaged by a user, initiates a workflow in the workflow client with one or more data elements of the instructions automatically prefilled in a graphical user interface of the workflow client software.

2. The system of claim 1, wherein the bridging software is a plugin utilizing an application programming interface (API) of the email client software.

3. The system of claim 1, wherein the first security scheme is Kerberos and the second security scheme is a different single sign on (SSO) framework.

4. The system of claim 1, wherein the email client software is an Outlook-protocol based client.

5. The system of claim 1, wherein the instructions comprise a portable document format (PDF) file.

6. The system of claim 5, wherein the PDF file comprises one or more form-fillable fields.

7. The system of claim 5, wherein the PDF file is encrypted, wherein decryption credentials are obtained from a credentials server, and wherein the one or more data elements of the instructions are obtained from a decrypted version of the PDF file.

8. The system of claim 1, wherein the instructions comprise an office open extensible markup language (OOXML) file.

9. The system of claim 1, wherein the instructions comprise a photograph or scan of one or more handwritten instructions.

10. The system of claim 9, wherein the determination that the email contains instructions requiring initiation of a workflow comprises using optical character recognition (OCR) upon the instructions to identify one or more data elements of the instructions.

11. A method for modifying a plurality of existing graphical user interfaces (GUIs), comprising:
adding, via an email client plugin and to a GUI of the email client, a command to obtain, from an email accessible by the email client, instructions requiring initiation of a workflow in a workflow client;
in response to triggering the command:
automatically identifying, from the instructions, one or more data elements necessary to initiate the workflow in the workflow client;
automatically storing, in a document management server, a representation or copy of the instructions;
automatically initiating a workflow in the workflow client; and
automatically prefilling, in a GUI of the workflow client, one or more data fields with the one or more data elements.

12. The method of claim 11, wherein the instructions requiring initiation of a workflow in the workflow client are automatically determined from an attachment to the email accessible by the email client.

13. The method of claim 12, wherein the attachment is a PDF file comprising one or more form-fillable fields.

14. The method of claim 13, wherein the PDF file is encrypted and wherein decryption credentials are obtained from a credentials server different from a computing device on which the email client and workflow client are executed.

15. The method of claim 12, wherein the attachment is an OOXML file.

16. The method of claim 12, wherein the attachment is an image file comprising a photograph or scan of a handwritten instruction, and wherein the automatic determination of the instructions requiring initiation of a workflow comprises using OCR upon the image file to identify one or more data elements of the instructions.

17. A method of accurately initiating workflows in response to a received indication of intent, comprising:
receiving a digital communication comprising a digital attachment via communication client software;
automatically determining that the digital attachment contains instructions requiring initiation of a workflow in workflow client software;
automatically obtaining one or more data elements of the instructions from the digital attachment;
automatically converting security credentials from a first security scheme used by the communication client software to a second security scheme used by the workflow client software; and
providing a graphical user interface that, when engaged by a user, initiates a workflow in the workflow client with the one or more data elements of the instructions automatically prefilled in a graphical user interface of the workflow client software.

18. The method of claim 17, wherein the digital attachment is an image file comprising a photograph or scan of a handwritten instruction, and wherein the automatically obtaining one or more data elements comprises using OCR upon the image file.

19. The method of claim 17, wherein the digital attachment is a portable document format PDF file comprising one or more form-fillable fields which contain the one or more data elements.

20. The method of claim 17, wherein the first security scheme is Kerberos and the second security scheme is a different SSO framework.
